(19) United States
(12) Patent Application Publication
(10) Pub. No.: US 2013/0288594 A1
(43) Pub. Date: Oct. 31, 2013

(54) MOBILE DEVICE AND NEAR FIELD COMMUNICATION SYSTEM

(71) Applicant: ACER INCORPORATED, Taipei Hsien (TW)

(72) Inventor: Neng-Wen YEH, Taipei Hsien (TW)

(73) Assignee: Acer Incorporated, Taipei Hsien (TW)

(21) Appl. No.: 13/686,190

(22) Filed: Nov. 27, 2012

(30) Foreign Application Priority Data
Apr. 27, 2012 (TW) 101115078

(51) Int. Cl. H04W 12/08

(52) U.S. Cl. CPC H04W 12/08
USPC 455/26.1

(57) ABSTRACT

The present invention discloses a mobile device including a storage unit, at least one sensor, a first near field communication chip, and a processing unit. The storage unit stores a key list, wherein the key list includes a key and an activation condition corresponding to the key. The at least one sensor generates a posture information and/or a position information of the mobile device. The processing unit receives the posture information and/or the position information of the mobile device, and determines whether the posture information and/or the position information meet(s) the activation condition, wherein the mobile device transmits the key of the key list to a second near field communication chip by the first near field communication chip to enable a mechanism corresponding to the key when the posture information and/or the position information meet(s) the activation condition.

### CROSS REFERENCE TO RELATED APPLICATIONS

This application claims priority of Taiwan Patent Application No. 101115078, filed on Apr. 27, 2011, the entirety of which is incorporated by reference herein.

### BACKGROUND OF THE INVENTION

1. Field of the Invention

The present invention relates to a near field communication of a mobile device.

2. Description of the Related Art

Near field communication (NFC) is applied to devices which are in close proximity to each other. Near field communication can also applied to high reliability security elements for paying out money, identifying IDs, etc. Generally, most of the applications of near field communication are single message transmissions. Some security applications of near field communication may include user identifying mechanisms, wherein the user identifying mechanisms may determine an identity by quiz verifications or biometric identification of the software opened by users to increase security. However, the mechanisms for increasing security cause inconvenience for users in some conditions. For example, when a device is stolen, the device can avoid people who are not owner of the device to operate the device by the software which includes quiz verifications or biometric identification, etc., but these mechanisms will decrease the convenience of near field communication.

### BRIEF SUMMARY OF THE INVENTION

A detailed description is given in the following embodiments with reference to the accompanying drawings.

The present invention discloses a mobile device. The mobile device includes a storage unit, at least one sensor, a first near field communication chip, and a processing unit. The storage unit is arranged to store a key list, wherein the key list includes a key and an activation condition corresponding to the key. The at least one sensor is arranged to generate a posture information and/or a position information of the mobile device. The processing unit is arranged to receive the posture information and/or the position information of the mobile device, and determine whether the posture information and/or the position information meet(s) the activation condition, wherein the mobile device is arranged to transmit the key of the key list to a second near field communication chip connected to a server by the first near field communication chip in order to enable a mechanism corresponding to the key when the posture information and/or the position information meet(s) the activation condition.

Additionally, the present invention further discloses a near field communication system. The near field communication system includes a mobile device, a storage unit, at least one sensor, a first near field communication chip, a processing unit, and a second near field communication chip. The storage unit is arranged to store a key list, wherein the key list includes at least one key and an activation condition corresponding to the key. The at least one sensor is arranged to generate a posture information and/or a position information of the mobile device. The processing unit is arranged to receive the posture information and/or the position information of the mobile device, and determine whether the posture information and/or the position information meet(s) the activation condition. The second near field communication chip is coupled to a server, wherein the mobile device is arranged to transmit the key of the key list to the second near field communication chip by the first near field communication chip in order to force the server to enable a mechanism corresponding to the key when the posture information and/or the position information meet(s) the activation condition.

### BRIEF DESCRIPTION OF THE DRAWINGS

The present invention can be more fully understood by reading the subsequent detailed description and examples with references made to the accompanying drawings, wherein:

FIG. 1 is a schematic diagram illustrating a near field communication system according to the exemplary embodiments;

FIG. 2 is a schematic diagram illustrating an embodiment of determining whether a key is transmitted according to a position information;

FIG. 3 is a schematic diagram illustrating an embodiment of determining whether a key is transmitted according to a posture information; and

FIG. 4 is a schematic diagram illustrating another embodiment of determining whether a key is transmitted according to a posture information.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

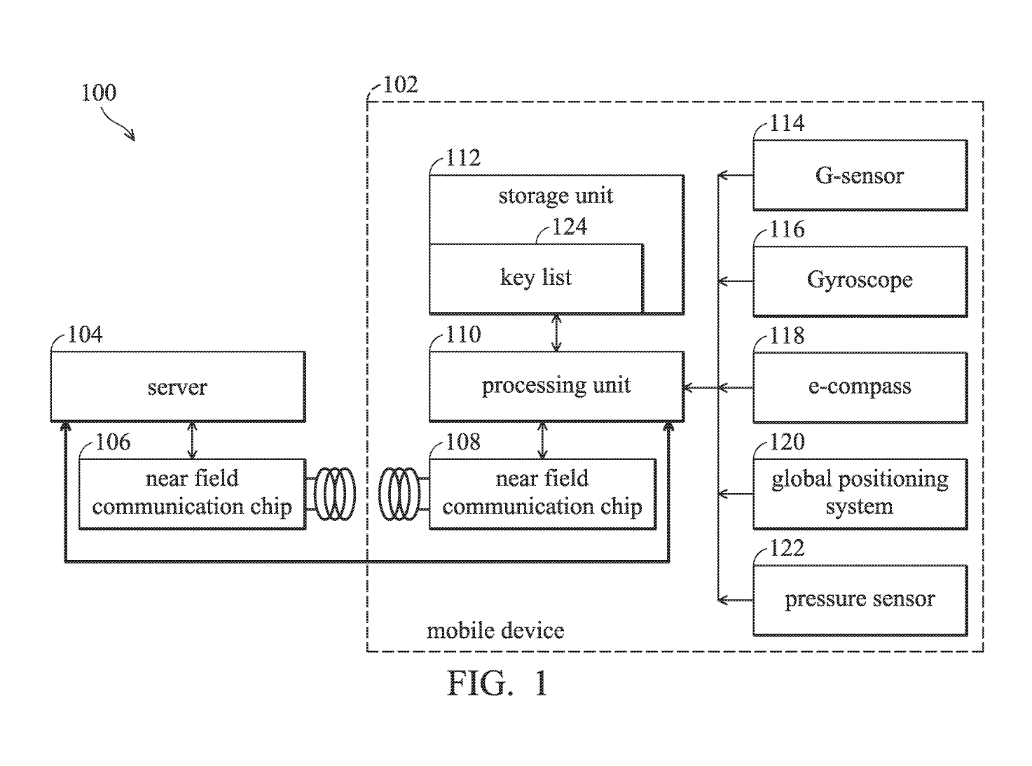

FIG. 1 is a schematic diagram illustrating a near field communication system 100 according to the exemplary embodiments. The near field communication system 100 includes a mobile device 102, a server 104, and a near field communication chip 106 (NFC chip). For example, the mobile device 102 can be a cell phone, a smart phone, a PDA phone and/or other mobile devices using the near field communication. The server 104 is coupled to the near field communication chip 106 to communicate with the mobile device 102 in near fields. The mobile device 102 includes a near field communication chip 108, a processing unit 110, a storage unit 112, a G-sensor 114, a Gyroscope 116, an e-compass 118, a global positioning system 120, and a pressure sensor 122. For example, the processing unit 110 is coupled to the near field communication chip 108, the storage unit 112, the G-sensor 114, the Gyroscope 116, the e-compass 118, the global positioning system 120 and the pressure sensor 122. In another embodiment, the mobile device 102 can only include at least one of the G-sensor 114, the Gyroscope 116, the e-compass 118, the global positioning system 120 and the pressure sensor 122.

For example, the processing unit 110 comprises a single central processing unit (CPU), a micro processing unit (MPU) or multiple processing units, commonly referred to as a parallel processing environment used for executing an operation system, module, and application. The storage unit 112 includes a read only memory (ROM), a flash ROM, a random access memory (RAM), an erasable programmable read-only memory, an electronic erasable programmable read-only memory, a registers, a hard disk, and/or any other type of computer-readable storage media to store program modules executed by the processing unit 110. Generally, program modules include routines, programs, objects, components, etc. used for executing the function of instant message switching of point-to-point near field communication.

The storage unit 112 is arranged to store a key list 124, wherein the key list 124 includes at least one key, and each of the at least one key includes a corresponding activation condition and a corresponding mechanism. In the embodiment, the activation condition can be a predetermined posture pattern, a predetermined position information, or other combinations, it is not limited thereto. For example, the predetermined posture pattern can be a static posture and/or a continuous motion of the mobile device 102, and the predetermined position information is arranged to indicate the geographic information of an area, wherein the continuous motion may include shaking up and down and/or rotating. In the embodiment, the G-sensor 114, the Gyroscope 116, the e-compass 118, the global positioning system 120, and the pressure sensor 122 are arranged to detect the movement, the posture, the direction, the location, and/or the pressure of the mobile device 102 to generate the current posture information and/or the current position information of the mobile device 102, wherein the posture of the mobile device 102 can be upright, laid down or tilted. For example, the key list 124 includes a first key corresponding to a mechanism for making payments of less than 1000 dollars, a second key corresponding to a mechanism for making payments of less than 10000 dollars, and a third key corresponding to a mechanism for opening a vault.

When the processing unit 110 receives the posture information and/or the position information of the mobile device 102 generated by the G-sensor 114, the Gyroscope 116, the e-compass 118, the global positioning system 120 and/or the pressure sensor 122 and determines whether the posture information and/or the position information meet(s) the activation condition of the key list 124, the processing unit 110 is arranged to retrieve a key corresponding to an activation condition of the key list 124, wherein the activation condition is the predetermined posture pattern and/or the predetermined position information. In some of the exemplary embodiments, the key can be constituted by different numbers or characters of the posture information and the position information. In one of the exemplary embodiments, the key can include the posture information, the position information, or the combination of the posture information and the position information. Furthermore, the mobile device 102 is arranged to force the near field communication chip 108 to transmit the key corresponding the current posture information and the current position information of the mobile device 102 in order to communicate with the near field communication chip 106 which is connected to the server 104. The server 104 is arranged to receive the signal including the key from the near field communication chip 106, and enable the mechanism corresponding to the key, as the following discussion illustrates.

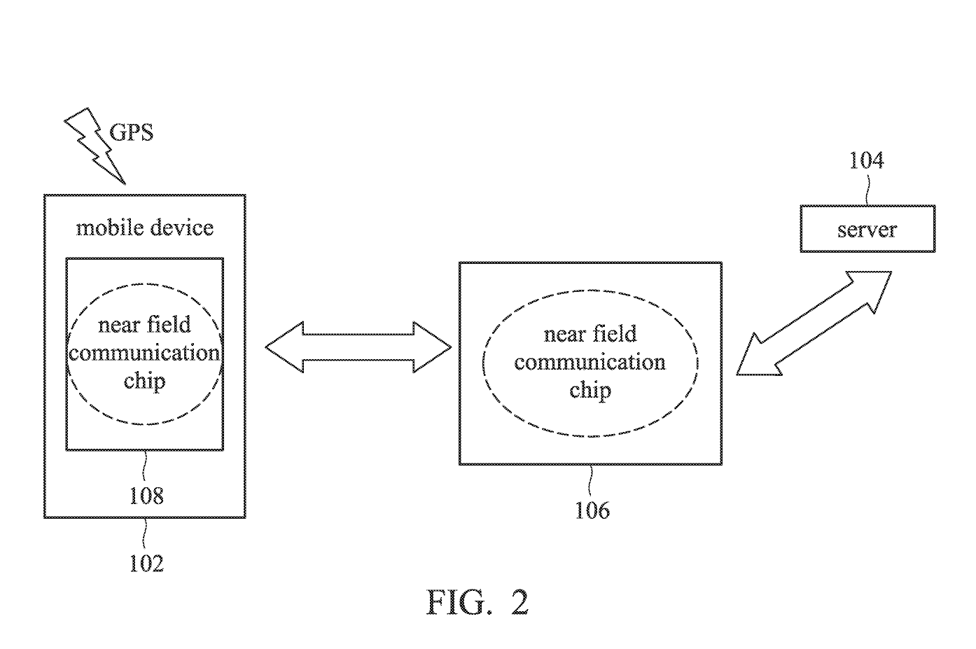

In one of the exemplary embodiments, a mechanism for paying out money through the near filed communication of the mobile device 102 is set to be enabled only in Taipei city. Namely, the activation condition corresponds to the position information. In the embodiment, when the location of the mobile device 102 is not in Taipei, the mechanism for paying out money is not able to be activated, such that the mobile device 102 can not be used to pay out money through the near filed communication. For example, as shown in FIG. 2, the mobile device 102 is arranged to pay out money through the near filed communication. The processing unit 110 of the mobile device 102 retrieves a signal from the global positioning system 120; that is, the position information of the mobile device 102. Next, the processing unit 110 determines whether the current location of the mobile device 102 is in a predetermined area according to the position information of the global positioning system 120. Namely, the processing unit 110 determines whether the position information of the global positioning system 120 meets a predetermined activation condition of a key in the key list 12. When the position information of the global positioning system 120 meets the predetermined position information of the mobile device 102, the processing unit 110 retrieves the corresponding key of the key list 124. Next, the processing unit 110 forces the near field communication chip 108 to transmit the key corresponding to the position information to the near field communication chip 106 which is connected to the server 104. The server 104 enables the mechanism corresponding to the key for paying out money after receiving the key from the near field communication chip 106, such that the mobile device 102 can pay out money through near field communication by the near field communication chip 108 and near field communication chip 106. When the position information of the global positioning system 120 does not meet the predetermined position information of the mobile device 102, the processing unit 110 is not able to transmit the key corresponding to the position information to the near field communication chip 106 which is connected to the server 104. Therefore, the mobile device 102 can not pay out money through the near field communication.

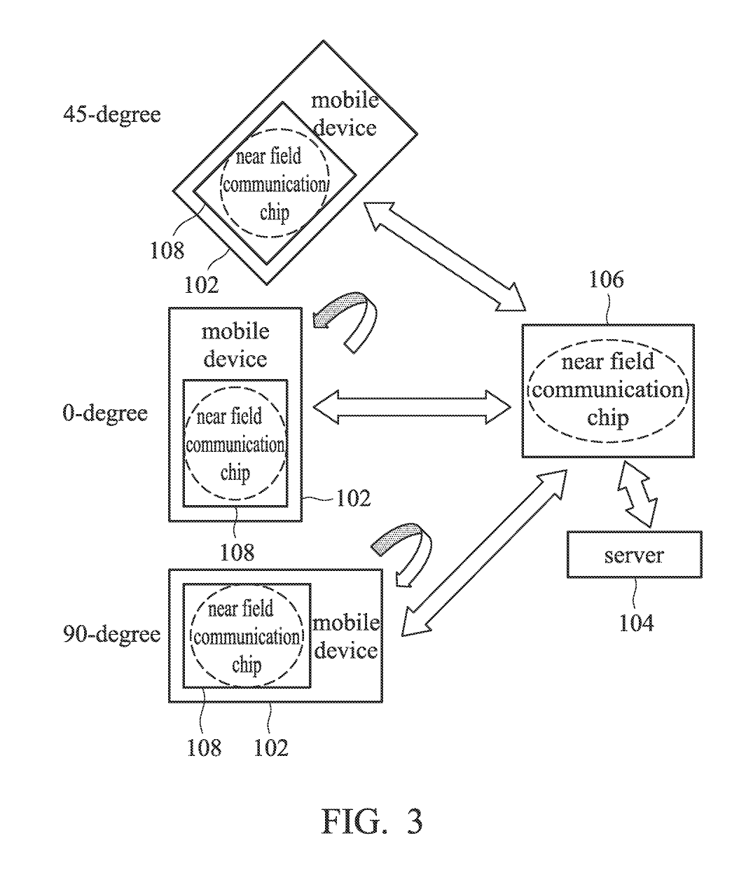

In another embodiment of the exemplary embodiments, a mechanism for opening a vault through the near filed communication of the mobile device 102 is set to be enabled only when the mobile device 102 continuous to be rotated by a number of different predetermined angles. Namely, the mechanism for opening a vault through the near filed communication of the mobile device 102 is set to be enabled only when the mobile device 102 meets a predetermined posture pattern. When the mobile device 102 is not continuously rotated by the predetermined angles in a predetermined order, the mechanism for opening a vault through the near filed communication of the mobile device 102 is not able to be activated. For example, as shown in FIG. 3, the mobile device 102 is arranged to open a vault through the near filed communication by the mobile device 102. The mobile device 102 is required to be rotated to a 45-degree angle to force the Gyroscope 116 to generate a first posture information, and rotated to a 0-degree angle to force the Gyroscope 116 to generate a second posture information, and finally rotated to a 90-degree angle to force the Gyroscope 116 to generate a third posture information. Next, the processing unit 110 receives the first, the second, and the third posture information from the Gyroscope 116, and determines whether the rotated angles and order thereof of the mobile device 102 meet the predetermined activation condition of the mobile device 102 according to the first, the second, and the third posture information. When the rotated angles and orders thereof of the mobile device 102 meet the predetermined activation condition of the mobile device 102, the processing unit 110 retrieves the corresponding key of the key list 124. Namely, when the rotated angles and orders thereof of the mobile device 102 meet the predetermined posture pattern of the mobile device 102, the processing unit 110 retrieves the corresponding key of the key list 124. Next, the processing unit 110 forces the near field communication chip 108 to transmit the key corresponding to the activation condition to the near field communication chip 106 which is connected to the server 104. The server 104 enables the mechanism corresponding to the key for opening a vault after receiving the key from the near field communication chip 106, such that the mobile device 102 can open the vault through near field communication by the near field communication chip 108 and near field communication chip 106. When the rotated angles and orders thereof of the mobile device 102 do not meet the predetermined activation condition of the mobile device 102, the processing unit 110 is not able to transmit the key for opening a vault to the near field communication chip 106 which is connected to the server 104. Namely, when the rotated angles and orders thereof of the mobile device 102 do not meet the predetermined posture pattern of the mobile device 102, the processing unit 110 is not able to transmit the key for opening a vault to the near field communication chip 106 which is connected to the server 104. Therefore, the mobile device 102 can not open the vault through the near field communication.

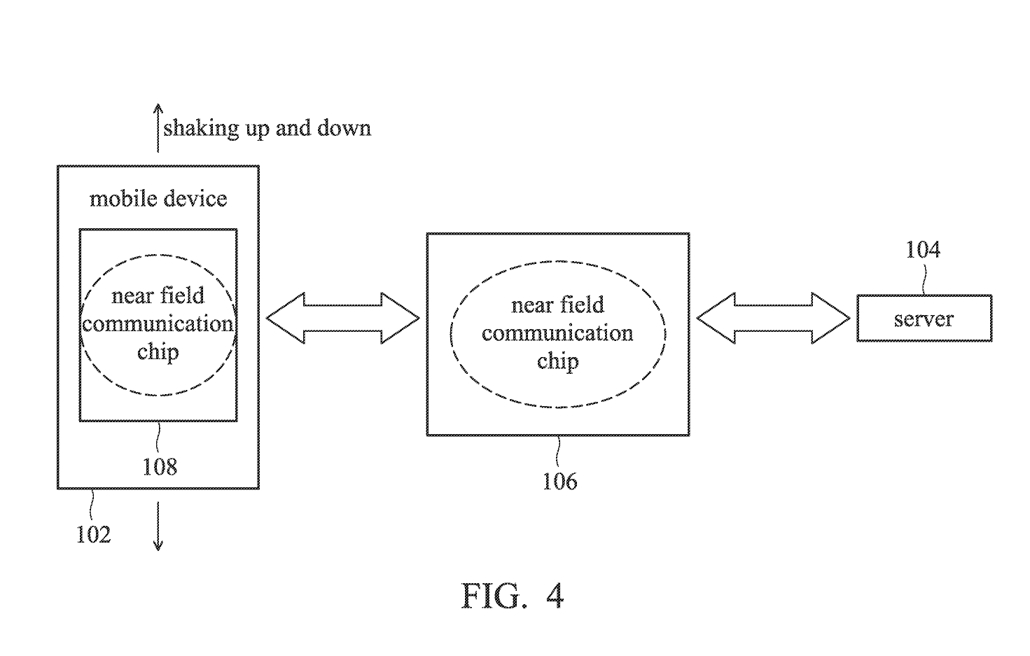

In another embodiment of the exemplary embodiments, a mechanism for removing an access control through the near filed communication of the mobile device 102 is set to be enabled only when the mobile device 102 is shaking up and down by a predetermined time(s). Namely, the mechanism for opening a vault through the near filed communication of the mobile device 102 is set to be enabled only when the mobile device 102 meets the predetermined posture pattern. When the mobile device 102 is not shaken up and down by the predetermined time(s), the mechanism for removing an access control through the near filed communication of the mobile device 102 is not able to be activated. For example, as shown in FIG. 4, the mobile device 102 is arranged to remove an access control through the near filed communication by the mobile device 102. The mobile device 102 is shaken 5 times, and the processing unit 110 of the mobile device 102 receives a posture information from the G-sensor 114 and determines whether the amount of times for shaking of the mobile device 102 meets the predetermined activation condition of the key list 124 according to the posture information of the G-sensor 114. When the amount of times for shaking of the mobile device 102 meets the predetermined activation condition, the processing unit 110 retrieves the corresponding key of the key list 124. Namely, when the amount of times for shaking of the mobile device 102 meets the predetermined posture pattern of the mobile device 102, the processing unit 110 retrieves the corresponding key of the key list 124. Next, the processing unit 110 forces the near field communication chip 108 to transmit the key corresponding to the activation condition to the near field communication chip 106 which is connected to the server 104. The server 104 enables the mechanism corresponding to the key for removing an access control after receiving the key from the near field communication chip 106, such that the mobile device 102 can remove the access control through near field communication by the near field communication chip 108 and the near field communication chip 106. When the amount of times for shaking of the mobile device 102 does not meet the predetermined activation condition, the processing unit 110 is not able to transmit the key corresponding to the mechanism for removing an access control to the near field communication chip 106 which is connected to the server 104. Namely, when the amount of times for shaking of the mobile device 102 does not meet the predetermined posture pattern, the processing unit 110 is not able to transmit the key corresponding to the mechanism for removing an access control to the near field communication chip 106 which is connected to the server 104. Therefore, the mobile device 102 can not remove the access control through the near field communication.

In another embodiment of the exemplary embodiments, the activation condition of the key(s) can be predetermined by various sensors, such as the G-sensor 114, the Gyroscope 116, the e-compass 118, the global positioning system 120, and the pressure sensor 122. For example, a key of the key list 124 can be set as the mobile device 102 being shaken 10 times and the mobile device 102 being rotated to a 45-degree angle to be an activation condition, wherein the key corresponds to a mechanism for making payments of less than 1000 dollars. For example, the processing unit 110 of the mobile device 102 receives a posture information from the Gyroscope 116 and the G-sensor 114, and determines whether the posture information meets the predetermined activation condition of the mobile device 102. When the posture information received by the processing unit 110 meets the activation condition of the mobile device 102, the processing unit 110 retrieves the corresponding key of the key list 124. Next, the processing unit 110 forces the near field communication chip 108 to transmit the key corresponding to the activation condition to the near field communication chip 106 which is connected to the server 104. The server 104 enables the mechanism corresponding to the key for making payments of less than 1000 dollars after receiving the key from the near field communication chip 106, such that the mobile device 102 can be paid under 1000 dollars through near field communication by the near field communication chip 108 and the near field communication chip 106.

For another example, a key of the key list 124 can be set as an activation condition to include the mobile device 102 being shaken 20 times, the mobile device 102 being rotated 90-degree, and the mobile device 102 being located in Taipei, wherein the key corresponds to a mechanism for making payments of less than 3000 dollars. The processing unit 110 of the mobile device 102 receives a posture information and a position information from the Gyroscope 116, the G-sensor 114, and the global positioning system 120, and determines whether the posture information and the position information meet the predetermined activation condition of the key list 124. When the posture information and the position information received by the processing unit 110 meet the predetermined posture pattern and the predetermined position information of the mobile device 102, the processing unit 110 retrieves the corresponding key of the key list 124. Namely, when the posture information and the position information received by the processing unit 110 meet the activation condition of the mobile device 102, the processing unit 110 retrieves the corresponding key of the key list 124. Next, the processing unit 110 forces the near field communication chip 108 to transmit the key corresponding to the activation condition to the near field communication chip 106 which is connected to the server 104. The server 104 enables the mechanism corresponding to the key for making payments of less than 3000 dollars after receiving the key from the near field communication chip 106, such that the mobile device 102 can be paid under 3000 dollars through near field communication by the near field communication chip 108 and the near field communication chip 106. In short, in the exemplary embodiments, the processing unit 110 is arranged to compare the current posture information and/or the current position information with the activation condition of the key list 124 for identification. When the current posture information and/or the current position information meet(s) the activation condition, the identification is successful, and the processing unit 110 transmits the key corresponding to the activation condition to the near field communication chip 106 in order to force the server 104 to enable the mechanism corresponding to the key. Namely, the activation condition of the exemplary embodiments serves as the identify condition of the identification, wherein the identification is successful when the activation condition is satisfied.

The mobile device of the exemplary embodiments determines the key by the posture information, such that the mobile device can keep the convenience of near filed communication and change different keys by different postures. Furthermore, the exemplary embodiments can prevent the payment mechanism of the mobile device from being compromised to increase the security when the mobile device is lost.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A mobile device, comprising:
a storage unit, arranged to store a key list, wherein the key list comprises a key and an activation condition corresponding to the key;
at least one sensor, arranged to generate a posture information and/or a position information of the mobile device;
a first near field communication chip; and
a processing unit, arranged to receive the posture information and/or the position information of the mobile device, and determine whether the posture information and/or the position information meet(s) the activation condition, wherein the mobile device is arranged to transmit the key of the key list to a second near field communication chip connected to a server by the first near field communication chip in order to enable a mechanism corresponding to the key when the posture information and/or the position information meet(s) the activation condition.

2. The mobile device as claimed in claim 1, wherein the activation condition comprises a predetermined posture pattern and/or a predetermined position information.

3. The mobile device as claimed in claim 2, wherein the predetermined posture pattern is generated by a static posture and/or a continuous motion.

4. The mobile device as claimed in claim 3, wherein the continuous motion comprises shaking up and down and/or rotating.

5. The mobile device as claimed in claim 1, wherein the key comprises the posture information and/or the position information.

6. The mobile device as claimed in claim 1, wherein the at least one sensor comprises at least one of a G-sensor, a Gyroscope, an e-compass, a global positioning system and pressure sensor.

7. The mobile device as claimed in claim 1, wherein the enabled mechanism is used for paying out money, opening a vault or removing an access control.

8. A near field communication system, comprising:
a mobile device, comprising:
a storage unit, arranged to store a key list, wherein the key list comprises at least one key and an activation condition corresponding to the key;
at least one sensor, arranged to generate a posture information and/or a position information of the mobile device;
a first near field communication chip;
a processing unit, arranged to receive the posture information and/or the position information of the mobile device, and determine whether the posture information and/or the position information meet(s) the activation condition; and
a second near field communication chip, coupled to a server;
wherein the mobile device is arranged to transmit the key of the key list to the second near field communication chip by the first near field communication chip in order to force the server to enable a mechanism corresponding to the key when the posture information and/or the position information meet(s) the activation condition.

9. The near field communication system as claimed in claim 8, wherein the enabled mechanism is used for paying out money, opening a vault or removing an access control.

10. The near field communication system as claimed in claim 8, wherein the activation condition comprises a predetermined posture pattern and/or a predetermined position information.
